(19) United States
(12) Patent Application Publication
(10) Pub. No.: US 2025/0311773 A1
(43) Pub. Date: Oct. 9, 2025

(54) AEROSOL-GENERATING ARTICLE AND AEROSOL-GENERATING SYSTEM

(71) Applicant: KT&G CORPORATION, Daejeon (KR)

(72) Inventors: Chul Ho JANG, Daejeon (KR); Gyoung Min GO, Daejeon (KR); Hyung Jin BAE, Daejeon (KR); Jangwon SEO, Daejeon (KR); Jong Seong JEONG, Daejeon (KR); Jinchul JUNG, Daejeon (KR)

(73) Assignee: KT&G CORPORATION, Daejeon (KR)

(21) Appl. No.: 18/867,493

(22) PCT Filed: Jun. 2, 2023
(86) PCT No.: PCT/KR2023/007659

§ 371 Date: Nov. 20, 2024

(30) Foreign Application Priority Data
Sep. 13, 2022 (KR) 10-2022-0114970

(51) Int. Cl. A24F 40/42; A24F 40/465

(52) U.S. Cl. CPC A24F 40/42; A24F 40/465

(57) ABSTRACT

An aerosol-generating article according to various embodiments comprises: a medium part, which comprises a first medium surface, a second medium surface formed on the opposite side of the first medium surface, and at least one side medium surface, perpendicular to the first medium surface and the second medium surface; an outer cover part, which comprises a first cover surface corresponding to the first medium surface of the medium part, a second cover surface corresponding to the second medium surface, and a side cover surface corresponding to the side medium surface and which is made of a porous material; and a susceptor arranged in correspondence to the first cover surface and the second cover surface, wherein the medium may be either inserted into an aerosol-generating device and then transferred by means of heating, or directly transferred by being inserted into a user's mouth.

### TECHNICAL FIELD

The following embodiments relate to an aerosol generating article and an aerosol generating system.

### BACKGROUND ART

Recently, demands for alternative articles to overcome disadvantages of general cigarettes have increased. For example, there is an increasing demand for a device (e.g., a cigarette-type electronic cigarette) that generates an aerosol by electrically heating a cigarette stick. Accordingly, research on an electrically heated aerosol generating device and a cigarette stick (or an aerosol generating article) applied thereto is being actively conducted. For example, Korean Patent Application Publication No. 10-2017-0132823 discloses a non-combustion-type flavor inhaler, a flavor inhalation component source unit, and an atomizing unit.

### DISCLOSURE OF THE INVENTION

### Technical Goals

An object according to an embodiment is to provide an aerosol generating article that may be used as a medium for both chewing tobacco and heated tobacco, and an aerosol generating system including the aerosol generating article.

Another object according to an embodiment is to provide an aerosol generating article for increasing user satisfaction by preserving a moisture content and fragrance with a packaging material, and an aerosol generating system including the aerosol generating article.

### Technical Solutions

An aerosol generating article according to various embodiments includes a medium portion including a first medium surface, a second medium surface formed on a side opposite to the first medium surface, and one or more medium side surfaces perpendicular to the first medium surface and the second medium surface, an outer cover portion including a first outer cover surface corresponding to the first medium surface of the medium portion, a second outer cover surface corresponding to the second medium surface, and outer cover side surfaces corresponding to the medium side surfaces, and formed of a porous material, and a susceptor disposed to correspond to the first outer cover surface and the second outer cover surface. A medium is transferred by one of a method in which the aerosol generating article is inserted into an aerosol generating device such that the medium is transferred through heating or a method in which the aerosol generating article is inserted into user's mouth such that the medium is directly transferred.

In an embodiment, the aerosol generating article may further include a wrapper portion configured to wrap at least a portion of the outer cover portion, and the wrapper portion may include a first wrapper surface corresponding to the first outer cover surface, a second wrapper surface corresponding to the second outer cover surface, and wrapper side surfaces corresponding to the outer cover side surfaces.

In an embodiment, the susceptor may surround at least a portion of the wrapper portion and a remaining portion of the wrapper portion that is not surrounded by the susceptor may have a porous property.

In an embodiment, the susceptor may surround the first wrapper surface and the second wrapper surface of the wrapper portion.

In an embodiment, the wrapper side surfaces may include a third wrapper surface, a fourth wrapper surface formed on a side opposite to the third wrapper surface, a fifth wrapper surface perpendicular to the third wrapper surface and the fourth wrapper surface, and a sixth wrapper surface formed on a side opposite to the fifth wrapper surface, and the susceptor and the wrapper portion may include a cutting line drawn from the third wrapper surface to the fourth wrapper surface.

In an embodiment, the aerosol generating article may further include a susceptor surrounding at least a portion of the outer cover portion, and a wrapper portion configured to wrap the susceptor and the outer cover portion, and the wrapper portion may include a first wrapper surface corresponding to the first medium surface, a second wrapper surface corresponding to the second medium surface, and wrapper side surfaces corresponding to the medium side surfaces, and formed of a thermally conductive material.

In an embodiment, the aerosol generating article may further include a filter portion, and the filter portion may contact with at least one of the first medium surface or the second medium surface.

In an embodiment, the first medium surface and the second medium surface may have the same shape and area.

An aerosol generating system according to various embodiments includes an aerosol generating device, and an aerosol generating article accommodated inside the aerosol generating device. The aerosol generating device includes a housing including a first housing end and a second housing end on a side opposite to the first housing end, a mouthpiece unit detachably coupled to the first housing end of the housing, a medium accommodation portion disposed inside the housing and including a first wall and a second wall facing the first wall, and an induction coil disposed on outside of the first wall and the second wall of the medium accommodation portion to generate an induced magnetic field on the aerosol generating article accommodated in the medium accommodation portion, and the aerosol generating article includes a medium portion including a first medium surface, a second medium surface formed on a side opposite to the first medium surface, and one or more medium side surfaces perpendicular to the first medium surface and the second medium surface, an outer cover portion surrounding the first medium surface, the second medium surface, and the medium side surfaces of the medium portion, and formed of a porous material, and a susceptor disposed to correspond to the first medium surface and the second medium surface.

In an embodiment, the susceptor corresponds to at least a portion of the medium side surfaces of the aerosol generating article.

In an embodiment, the induction coil of the aerosol generating device may be disposed at a position corresponding to a surface including the susceptor of the aerosol generating article.

In an embodiment, the first medium surface and the second medium surface may have the same shape and area, the shape of the first medium surface and the second medium surface may be a rectangle, and a width between the first medium surface and the second medium surface of the aerosol generating article may be larger than or equal to a width between the first wall and the second wall of the medium accommodation portion.

### Effects

An aerosol generating article according to an embodiment may be used as a medium for both chewing tobacco and heated tobacco.

An aerosol generating article according to an embodiment and an aerosol generating system including the same may increase user satisfaction by preserving a moisture content and fragrance with a packaging material.

The effects of the aerosol generating article and the aerosol generating system according to an embodiment are not limited to the above-mentioned effects, and other unmentioned effects may be clearly understood from the following description by one of ordinary skill in the art.

### BRIEF DESCRIPTION OF DRAWINGS

FIG. 1 is a block diagram of an aerosol generating device according to an embodiment.

FIG. 2A is a perspective view of an aerosol generating article according to an embodiment with a portion that is cut out.

FIG. 2B is an exploded perspective view of an aerosol generating article according to an embodiment.

FIG. 3A is a perspective view of an aerosol generating article according to an embodiment with a portion that is cut out.

FIG. 3B is an exploded perspective view of an aerosol generating article according to an embodiment.

FIG. 4A is a perspective view of an aerosol generating article according to an embodiment with a portion that is cut out.

FIG. 4B is an exploded perspective view of an aerosol generating article according to an embodiment.

FIG. 5A is a perspective view of an aerosol generating system according to an embodiment.

FIG. 5B is a cross-sectional view of an aerosol generating system according to an embodiment.

### BEST MODE FOR CARRYING OUT THE INVENTION

The terms used in the embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In the following embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In the following embodiments, the term “upstream” or “upstream direction” may refer to a direction away from an oral region of a user (smoker), and the term 20 “downstream” or “downstream direction” may refer to a direction approaching the oral region of the user. The terms “upstream” and “downstream” may be used to describe relative positions of components of an aerosol generating article.

In the following embodiments, the term “puff” refers to inhalation by a user, and the inhalation refers to a situation in which a user draws in an aerosol into his or her oral cavity, nasal cavity, or lungs through the mouth or nose.

In an embodiment, an aerosol generating device may be a device that generates an aerosol by electrically heating an aerosol generating article accommodated in an inner space.

The aerosol generating device may include a heater. In an embodiment, the heater may be an electrically resistive heater. For example, the heater may include an electrically conductive track, and the heater may be heated as a current flows through the electrically conductive track.

The heater may include a tubular heating element, a plate-shaped heating element, a needle-shaped heating element, or a rod-shaped heating element, and may heat the inside or outside of the aerosol generating article according to the shape of a heating element.

The aerosol generating article may include a tobacco rod and a filter rod. The tobacco rod may be formed as a sheet or a strand, or may be formed of tobacco leaves finely cut from a tobacco sheet. In addition, the tobacco rod may be enveloped by a thermally conductive material. For example, the thermally conductive material may be metal foil such as aluminum foil. However, embodiments are not limited thereto.

The filter rod may be a cellulose acetate filter. The filter rod may include at least one segment. For example, the filter rod may include a first segment that cools an aerosol and a second segment that filters a predetermined ingredient contained in the aerosol.

In another embodiment, the aerosol generating device may be a device that generates an aerosol using a cartridge containing an aerosol generating material.

The aerosol generating device may include a cartridge containing the aerosol generating material and a main body supporting the cartridge. The cartridge may be detachably coupled to the main body. However, embodiments are not limited thereto. The cartridge may be integrally formed or assembled with the main body, and may be secured to the main body so as not to be detached by a user. The cartridge may be mounted on the main body while the aerosol generating material is accommodated therein. However, embodiments are not limited thereto. The aerosol generating material may be injected into the cartridge while the cartridge is coupled to the main body.

The cartridge may hold the aerosol generating material in any one of various states, such as a liquid state, a solid state, a gaseous state, and a gel state. The aerosol generating material may include a liquid composition. For example, the liquid composition may be a liquid including a tobacco-containing material having a volatile tobacco flavor component, or may be a liquid including a non-tobacco material.

The cartridge may be operated by an electrical signal or a wireless signal transmitted from the main body to perform the function of generating an aerosol by converting a phase of the aerosol generating material inside the cartridge to a gaseous phase. The aerosol may refer to a gas in which vaporized particles generated from the aerosol generating material are mixed with air.

In another embodiment, the aerosol generating device may generate an aerosol by heating the liquid composition, and the generated aerosol may pass through the cigarette and be delivered to the user. That is, the aerosol generated from the liquid composition may travel along an airflow path of the aerosol generating device, and the airflow path may be configured to allow the aerosol to pass through the cigarette and be delivered to the user.

In another embodiment, the aerosol generating device may be a device that generates an aerosol from the aerosol generating material using an ultrasonic vibration manner. In this case, the ultrasonic vibration manner may refer to a manner of generating an aerosol by atomizing the aerosol generating material with ultrasonic vibration generated by a vibrator.

The aerosol generating device may include a vibrator, and may generate vibration at short intervals through the vibrator to atomize the aerosol generating material. The vibration generated by the vibrator may be ultrasonic vibration, and a frequency band of the ultrasonic vibration may be from about 100 kilohertz (kHz) to about 3.5 megahertz (MHz). However, embodiments are not limited thereto.

The aerosol generating device may further include a wick that absorbs the aerosol generating material. For example, the wick may be disposed to surround at least one area of the vibrator or may be disposed to contact at least one area of the vibrator.

As a voltage (e.g., an alternating voltage) is applied to the vibrator, the vibrator may generate heat and/or ultrasonic vibration, and the heat and/or ultrasonic vibration generated by the vibrator may be transmitted to the aerosol generating material absorbed in the wick. The aerosol generating material absorbed in the wick may be converted into a gas phase by the heat and/or ultrasonic vibration transmitted from the vibrator, and consequently, an aerosol may be generated.

For example, the viscosity of the aerosol generating material absorbed in the wick may be lowered by the heat generated by the vibrator, and the aerosol generating material whose viscosity is lowered may change to fine particles by the ultrasonic vibration generated by the vibrator, so that an aerosol may be generated. However, embodiments are not limited thereto.

In another embodiment, the aerosol generating device may be a device that generates an aerosol by heating the aerosol generating article accommodated therein in an induction heating manner.

The aerosol generating device may include a susceptor and a coil. In an embodiment, the coil may apply a magnetic field to the susceptor. As the aerosol generating device supplies power to the coil, a magnetic field may be formed inside the coil. In an embodiment, the susceptor may be a magnetic body that generates heat by an external magnetic field. As the susceptor is positioned inside the coil and generates heat with the magnetic field applied, the aerosol generating article may be heated. Also, optionally, the susceptor may be positioned in the aerosol generating article.

In another embodiment, the aerosol generating device may further include a cradle.

The aerosol generating device and the separate cradle may form a system together. For example, the cradle may be used to charge a battery of the aerosol generating device. Alternatively, a heater may be heated when the cradle and the aerosol generating device are coupled to each other.

Hereinafter, embodiments of the disclosure will be described in detail with reference to the accompanying drawings such that one of ordinary skill in the art may easily practice the disclosure. The disclosure may be practiced in forms that are implementable in the aerosol generating devices according to various embodiments described above or may be embodied and practiced in many different forms and is not limited to the embodiments described herein.

Hereinafter, embodiments of the disclosure will be described in detail with reference to the drawings.

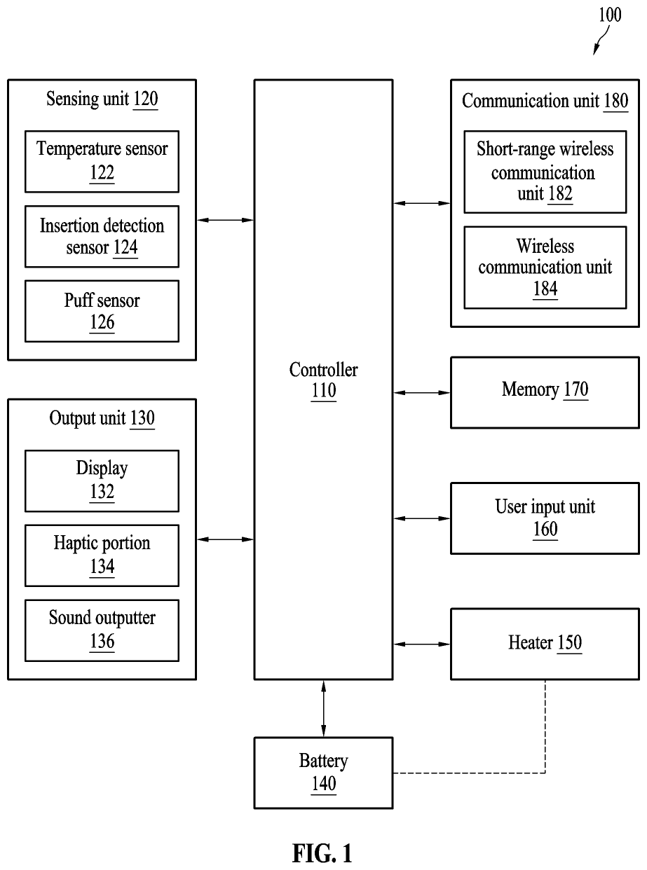

FIG. 1 is a block diagram of an aerosol generating device 100 according to an embodiment.

The aerosol generating device 100 may include a controller 110, a sensing unit 120, an output unit 130, a battery 140, a heater 150, a user input unit 160, a memory 170, and a communication unit 180. However, an internal structure of the aerosol generating device 100 is not limited to what is shown in FIG. 1. It is to be understood by one of ordinary skill in the art to which the disclosure pertains that some of the components shown in FIG. 1 may be omitted or new components may be added according to the design of the aerosol generating device 100.

The sensing unit 120 may sense a state of the aerosol generating device 100 or a state of an environment around the aerosol generating device 100, and transmit sensing information obtained through the sensing to the controller 110. Based on the sensing information, the controller 110 may control the aerosol generating device 100 to control operations of the heater 150, restrict smoking, determine whether an aerosol generating article (e.g., an aerosol generating article, a cartridge, etc.) is inserted, display a notification, and perform other functions.

The sensing unit 120 may include at least one of a temperature sensor 122, an insertion detection sensor 124, or a puff sensor 126. However, embodiments are not limited thereto.

The temperature sensor 122 may sense a temperature at which the heater 150 (or an aerosol generating material) is heated. The aerosol generating device 100 may include a separate temperature sensor for sensing the temperature of the heater 150, or the heater 150 itself may also function as a temperature sensor. Alternatively, the temperature sensor 122 may be arranged around the battery 140 to monitor a temperature of the battery 140.

The insertion detection sensor 124 may sense whether the aerosol generating article is inserted and/or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 126 may sense a puff from a user based on various physical changes in an airflow path or airflow channel. For example, the puff sensor 126 may sense the puff from the user based on one of a temperature change, a flow change, a voltage change, and a pressure change.

The sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 to 126 described above. A function of each sensor may be intuitively inferable from its name by one of ordinary skill in the art, and thus, a more detailed description thereof will be omitted here.

The output unit 130 may output information about the state of the aerosol generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

The display 132 may visually provide information about the aerosol generating device 100 to the user. The information about the aerosol generating device 100 may include, for example, a charging/discharging state of the battery 140 of the aerosol generating device 100, a preheating state of the heater 150, an insertion/removal state of the aerosol generating article, a limited usage state (e.g., an abnormal article detected) of the aerosol generating device 100, or the like, and the display 132 may externally output the information. The display 132 may be, for example, a liquid-crystal display panel (LCD), an organic light-emitting display panel (OLED), or the like. The display 132 may also be in the form of a light-emitting diode (LED) device.

The haptic portion 134 may provide information about the aerosol generating device 100 to the user in a haptic way by converting an electrical signal into a mechanical stimulus or an electrical stimulus. The haptic portion 134 may include, for example, a motor, a piezoelectric element, or an electrical stimulation device.

The sound outputter 136 may provide information about the aerosol generating device 100 to the user in an auditory way. For example, the sound outputter 136 may convert an electrical signal into a sound signal and externally output the sound signal.

The battery 140 may supply power to be used to operate the aerosol generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol generating device 100. The battery 140 may be a rechargeable battery or a disposable battery. The battery 140 may be, for example, a lithium polymer (LiPoly) battery. However, embodiments are not limited thereto.

The heater 150 may receive power from the battery 140 to heat the aerosol generating material. Although not shown in FIG. 1, the aerosol generating device 100 may further include a power conversion circuit (e.g., a direct current (DC)-to-DC (DC/DC) converter) that converts power of the battery 140 and supplies the power to the heater 150. In addition, when the aerosol generating device 100 generates an aerosol by induction heating, the aerosol generating device 100 may further include a DC-to-alternating current (AC) (DC/AC) converter that converts DC power of the battery 140 into AC power.

The controller 110, the sensing unit 120, the output unit 130, the user input unit 160, the memory 170, and the communication unit 180 may receive power from the battery 140 to perform functions. Although not shown in FIG. 1, the aerosol generating device 100 may further include a power conversion circuit, for example, a low dropout (LDO) circuit or a voltage regulator circuit, which converts power of the battery 140 and supplies the power to respective components.

In an embodiment, the heater 150 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like. However, embodiments are not limited thereto.

In another embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating the aerosol generating article and a second heater for heating a liquid.

The user input unit 160 may receive information input from the user or may output information to the user. For example, the user input unit 160 may include a key pad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol generating device 100 may further include a connection interface such as a universal serial bus (USB) interface, and may be connected to another external device through the connection interface such as a USB interface to transmit and receive information or to charge the battery 140.

The memory 170, which is hardware for storing various pieces of data processed in the aerosol generating device 100, may store data processed by the controller 110 and data to be processed by the controller 110. The memory 170 may include at least one type of storage medium of flash memory-type memory, hard disk-type memory, multimedia card micro-type memory, card-type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, or an optical disk. The memory 170 may store an operating time of the aerosol generating device 100, a maximum number of puffs, a current number of puffs, at least one temperature profile, data associated with a smoking pattern of the user, or the like.

The communication unit 180 may include at least one component for communicating with another electronic device. For example, the communication unit 180 may include a short-range wireless communication unit 182 and a wireless communication unit 184.

The short-range wireless communication unit 182 may include a Bluetooth communication unit, a Bluetooth low energy (BLE) communication unit, a near field communication unit, a wireless local area network (WLAN) (wireless fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 184 may include, for example, a cellular network communication unit, an Internet communication unit, a computer network (e.g., a LAN or wide-area network (WAN) communication unit, or the like. However, embodiments are not limited thereto. The wireless communication unit 184 may use subscriber information (e.g., international mobile subscriber identity (IMSI)) to identify and authenticate the aerosol generating device 100 in a communication network.

The controller 110 may control the overall operation of the aerosol generating device 100. In an embodiment, the controller 110 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the present disclosure pertains that it may be implemented in other types of hardware.

The controller 110 may control the temperature of the heater 150 by controlling supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

The controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. In another example, the controller 110 may control an amount of power to be supplied to the heater 150 and a time for which the power is to be supplied, such that the heater 150 may be heated up to a predetermined temperature or maintained at a desired temperature, based on the sensing result obtained by the sensing unit 120.

The controller 110 may control the output unit 130 based on the sensing result obtained by the sensing unit 120. For example, when the number of puffs counted through the puff sensor 126 reaches a preset number, the controller 110 may inform the user that the aerosol generating device 100 is to be ended soon, through at least one of the display 132, the haptic portion 134, or the sound outputter 136.

In an embodiment, the controller 110 may control a power supply time and/or a power supply amount for the heater 150 according to a state of the aerosol generating article sensed by the sensing unit 120. For example, when the aerosol generating article is in an over-humidified state, the controller 110 may control the power supply time for an inductive coil to increase a preheating time, compared to a case where the aerosol generating article is in a general state.

An embodiment may be implemented in the form of a recording medium including instructions executable by a computer, such as a program module executable by the computer. A computer-readable medium may be any available medium that may be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

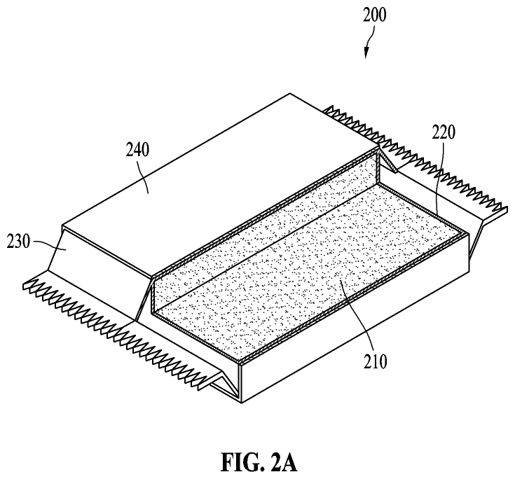

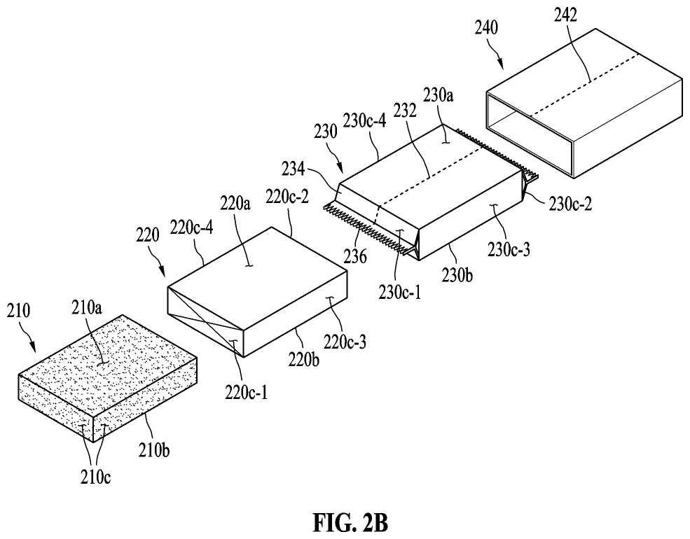

FIG. 2A is a perspective view of an aerosol generating article 200 according to an embodiment with a portion that is cut out. FIG. 2B is an exploded perspective view of the aerosol generating article 200 according to an embodiment.

In an embodiment, the aerosol generating article 200 may be formed in a shape of a cuboid, and may be transferred by one of a first method in which a medium is inserted into an aerosol generating device (e.g., the aerosol generating device 100 of FIG. 1) to be transferred through heating or a second method in which a medium is directly inserted into a user's mouth to be transferred. The first method or the second method may be selected according to the user's preference. In an embodiment, the aerosol generating article 200 may include a medium portion 210, an outer cover portion 220, a wrapper portion 230, and a susceptor 240.

The medium portion 210 may include a first medium surface 210a, a second medium surface 210b formed on a side opposite to the first medium surface 210a, and medium side surfaces 210c perpendicular to the first medium surface 210a and the second medium surface 210b. In an embodiment, the medium portion 210 may include one or more medium side surfaces 210c. In an embodiment, the first medium surface 210a and the second medium surface 210b may have the same area. In an embodiment, an area of the medium side surface 210c may be smaller than or equal to the area of the first medium surface 210a or the second medium surface 210b. In an embodiment, the first medium surface 210a and the second medium surface 210b may have the same shape. In an embodiment, the first medium surface 210a and the second medium surface 210b may have a triangular shape. In an embodiment, the first medium surface 210a and the second medium surface 210b may have a rectangular shape. In an embodiment, the first medium surface 210a and the second medium surface 210b may have a pentagonal shape. In an embodiment, the first medium surface 210a and the second medium surface 210b may have a hexagonal shape. In an embodiment, the first medium surface 210a and the second medium surface 210b may have a circular shape. In an embodiment, each area of the first medium surface 210a and/or the second surface 210b of the medium portion 210 of the aerosol generating article 200 may be larger than the area of the side surface 210c. That is, the aerosol generating article 200 may have a wide and flat shape.

The outer cover portion 220 may include a first outer cover surface 220a, a second outer cover surface 220b formed on a side opposite to the first outer cover surface 220a, and outer cover side surfaces 220c perpendicular to the first outer cover surface 220a and the second outer cover surface 220b. In an embodiment, the outer cover portion 220 may include one or more outer cover side surfaces 220c. In an embodiment, the first outer cover surface 220a and the second outer cover surface 220b may have the same area. In an embodiment, the first outer cover surface 220a and the second outer cover surface 220b may have the same shape. In an embodiment, an area of the outer cover side surface 220c may be smaller than or equal to the area of the first outer cover surface 220a or the second outer cover surface 220b. In an embodiment, the first outer cover surface 220a may correspond to the first medium surface 210a of the medium portion 210. In an embodiment, the second outer cover surface 220b may correspond to the second medium surface 210b of the medium portion 210. In an embodiment, the outer cover side surface 220c may correspond to the medium side surface 210c of the medium portion 210. The outer cover portion 220 may be formed of a porous material. In an embodiment, the outer cover portion 220 may be formed of a porous material through which an airflow may pass. For example, the outer cover portion 220 may be formed of a mesh. In an embodiment, the outer cover portion 220 may be disposed to cover at least one or more surfaces of the medium portion 210 to reduce the separation of media of the medium portion 210.

The wrapper portion 230 may include a first wrapper surface 230a, a second wrapper surface 230b formed on a side opposite to the first wrapper surface 230a, and wrapper side surfaces 230c perpendicular to the first wrapper surface 230a and the second wrapper surface 230b. In an embodiment, the wrapper portion 230 may include one or more wrapper side surfaces 230c. In an embodiment, the first wrapper surface 230a and the second wrapper surface 230b may have the same area. In an embodiment, the first wrapper surface 230a and the second wrapper surface 230b may have the same shape. In an embodiment, the first wrapper surface 230a may correspond to the first outer cover surface 220a of the outer cover portion 220. In an embodiment, the second wrapper surface 230b may correspond to the second outer cover surface 220b of the outer cover portion 220. In an embodiment, the wrapper side surface 230c may correspond to the outer cover side surface 220c of the outer cover portion 220. In an embodiment, the wrapper side surface 230c may include a third wrapper surface 230c-1, a fourth wrapper surface 230c-2, a fifth wrapper surface 230c-3, and a sixth wrapper surface 230c-4. The fourth wrapper surface 230c-2 may be formed on a side opposite to the third wrapper surface 230c-1. The sixth wrapper surface 230c-4 may be formed on a side opposite to the fifth wrapper surface 230c-3. The fifth wrapper surface 230c-3 and the sixth wrapper surface 230c-4 may be perpendicular to the third wrapper surface 230c-1 and the fourth wrapper surface 230c-2.

The wrapper portion 230 according to an embodiment may include a wrapper cutting line 232, wrapper wings 234, and a wing joint portion 236. The wrapper cutting line 232 according to an embodiment may be disposed on at least one of the first wrapper surface 230a or the second wrapper surface 230b, and may be drawn from the third wrapper surface 230-1 to the fourth wrapper surface 230-2. In an embodiment, the wrapper cutting line 232 may have a function of a guide line for making the wrapper portion 230 be easily torn when the wrapper portion 230 needs to be peeled off according to the user's needs. The wrapper wings 234 according to an embodiment may be formed on at least two of the wrapper side surfaces 230c of the wrapper portion 230 disposed opposite to each other. The wrapper wings 234 according to an embodiment may be formed at one end of the first wrapper surface 230a and one end of the second wrapper surface 230b obliquely in a direction facing each other. The wing joint portion 236 according to an embodiment may correspond to a joint portion formed by a contact of the wrapper wings 234 which are formed at one end of the first wrapper surface 230a and one end of the second wrapper surface 230b obliquely in a direction facing each other. The wrapper wings 234 and the wing joint portion 236 according to an embodiment may have a structure formed for firm sealing of the wrapper portion 230. When the aerosol generating article 200 according to an embodiment is inserted into an aerosol generating device (e.g., the aerosol generating device 100) to be transferred by heating, at least a portion of the wrapper portion 230 may be formed of a porous material in order for a medium to be transferred while being wrapped by the wrapper portion 230.

The susceptor 240 according to an embodiment may be disposed to correspond to at least the first outer cover surface 220a and the second outer cover surface 220b of the outer cover portion 220. The susceptor 240 according to an embodiment may be disposed to correspond to at least the first wrapper surface 230a and the second wrapper surface 230b of the wrapper portion 230. The susceptor 240 according to an embodiment may be disposed to surround to at least the first wrapper surface 230a and the second wrapper surface 230b of the wrapper portion 230. In an embodiment, the susceptor 240 may be formed of a material with high thermal conductivity. In an embodiment, the susceptor 240 may include a susceptor cutting line 242. The susceptor cutting line 242 according to an embodiment may be formed at a position corresponding to the wrapper cutting line 232. The susceptor cutting line 242 may have a function of a guide line for making the susceptor 240 be easily torn when the susceptor 240 needs to be peeled off according to the user's needs. The susceptor 240 according to an embodiment may have a function of a heating source when the aerosol generating article 200 is inserted into an aerosol generating device to be transferred through heating.

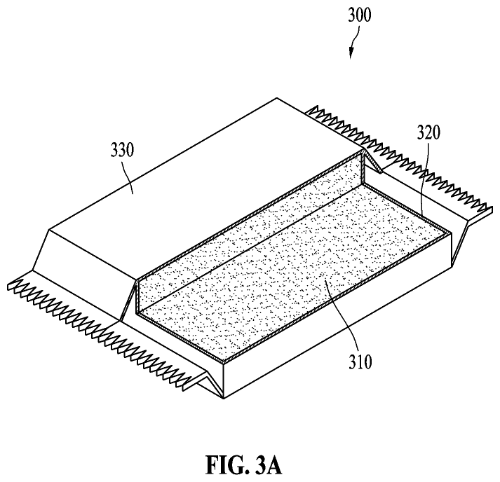

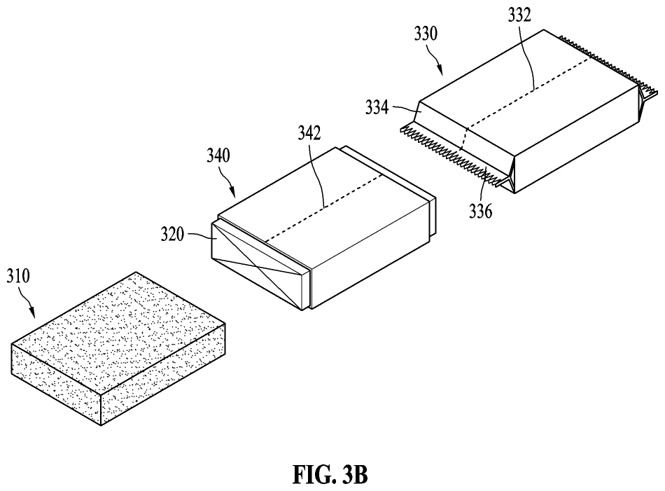

FIG. 3A is a perspective view of an aerosol generating article 300 according to an embodiment with a portion that is cut out. FIG. 3B is an exploded perspective view of the aerosol generating article 300 according to an embodiment. The common components to those in the aerosol generating article 200 according to the embodiment described above have been described in detail with reference to FIGS. 2A and 2B, and therefore, the description thereof will be omitted hereinafter.

In an embodiment, the aerosol generating article 300 (e.g., the aerosol generating article 200 of FIG. 2A) may be formed in a shape of a cuboid, and may be transferred by one of a first method in which a medium is inserted into an aerosol generating device (e.g., the aerosol generating device 100 of FIG. 1) to be transferred through heating or a second method in which a medium is directly inserted into a user's mouth to be transferred. In an embodiment, the aerosol generating article 300 may include a medium portion 310 (e.g., the medium portion 210 of FIG. 2A), an outer cover portion 320 (e.g., the outer cover portion 220 of FIG. 2A), a wrapper portion 330 (e.g., the wrapper portion 210 of FIG. 2A), and a susceptor 340 (e.g., the susceptor 240 of FIG. 2A).

The susceptor 340 according to an embodiment may surround at least a portion of the outer cover portion 320 surrounding the medium portion 310. The susceptor 340 surrounding the outer cover portion 320 may have a function of heating the medium portion 310 when the aerosol generating article 300 is inserted into an aerosol generating device (e.g., the aerosol generating device 100 of FIG. 1).

The wrapper portion 330 according to an embodiment may be formed to wrap the outer cover portion 320 and the susceptor 340. The wrapper portion 330 may include a first wrapper surface (e.g., the first wrapper surface 230a of FIG. 2B), a second wrapper surface (e.g., the second wrapper surface 230b of FIG. 2B) formed on a side opposite to the first wrapper surface 230a, and wrapper side surfaces (e.g., the wrapper side surfaces 230c of FIG. 2B) perpendicular to the first wrapper surface 230a and the second wrapper surface 230b. In an embodiment, the wrapper portion 330 may include one or more wrapper side surfaces 230c. The wrapper portion 330 according to an embodiment may be disposed to wrap the outer cover portion 320 and the susceptor 340 to completely preserve a moisture content, fragrance, and the like of the medium portion 310.

In an embodiment, the wrapper portion 330 may include a wrapper cutting line 332. The wrapper cutting line 232 according to an embodiment may be disposed at least one of the first wrapper surface 230a or the second wrapper surface 230b. In an embodiment, the wrapper cutting line 332 may have a function of a guide line for making the wrapper portion 330 be easily torn when the wrapper portion 330 needs to be peeled off according to the user's needs.

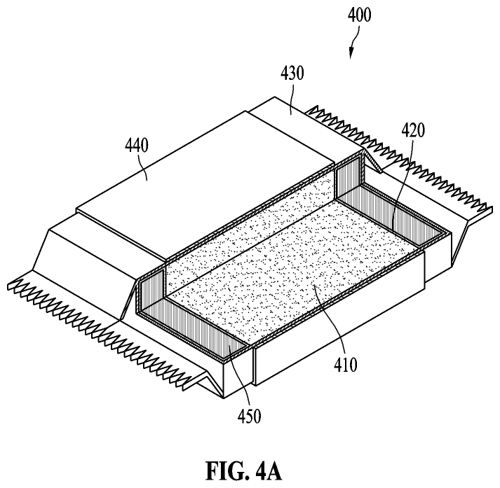

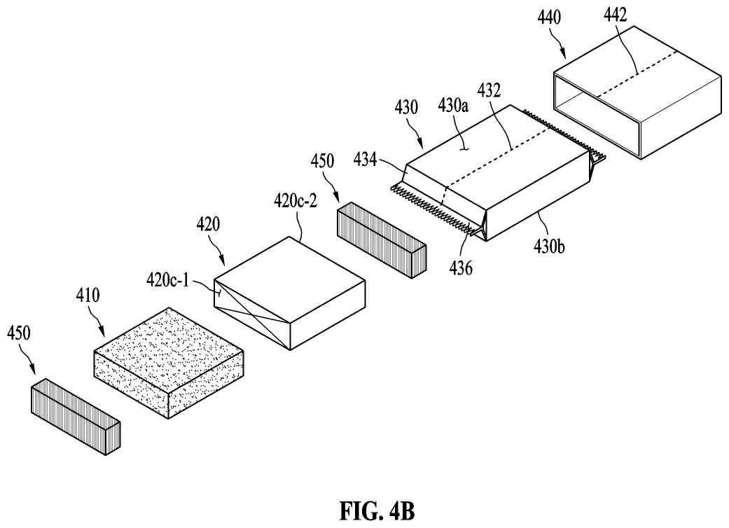

FIG. 4A is a perspective view of an aerosol generating article 400 according to an embodiment with a portion that is cut out. FIG. 4B is an exploded perspective view of the aerosol generating article 400 according to an embodiment. The common components to those in the aerosol generating article (200; 300) according to the embodiment described above have been described in detail with reference to FIGS. 2A to 3B, and therefore, the description thereof will be omitted hereinafter.

Referring to FIG. 4A, the aerosol generating article 400 may include a medium portion 410, an outer cover portion 420, a wrapper portion 430, a susceptor 440, and a filter portion 450.

In an embodiment, the outer cover portion 420 may be formed to cover at least a portion of the medium portion 410. The outer cover portion 420 may include a first outer cover surface (e.g., the first outer cover surface 220a of FIG. 2B), a second outer cover surface (e.g., the outer cover surface 220b of FIG. 2B) formed on a side opposite to the first outer cover surface 220a, and outer cover side surfaces 420c perpendicular to the first outer cover surface 220a and the second outer cover surface 220b. In an embodiment, the outer cover side surfaces 420c may include a third outer cover surface 420c-1 and a fourth outer cover surface 420c-2 formed on a side opposite to the third outer cover surface 420c-1. In an embodiment, the outer cover side surfaces 420c may further include a fifth outer cover surface (not shown) and a sixth outer cover surface (not shown) perpendicular to the third outer cover surface 420c-1 and the fourth outer cover surface 420c-2.

In an embodiment, the filter portion 450 may be disposed side by side with the medium portion 410 surrounded by the outer cover portion 420. In an embodiment, the filter portion 450 may be disposed in contact with at least one of the third outer cover surface 420c-1 or the fourth outer cover surface 420c-2 of the outer cover portion 420. In an embodiment, when the aerosol generating article 400 is inserted into an aerosol generating device (e.g., the aerosol generating device 100 of FIG. 1) such that a medium is transferred, an aerosol may move in a direction from the fourth outer cover surface 420c-2 to the third outer cover surface 420c-1, and the aerosol may be filtered by the filter portion 450. In an embodiment, the filter portion 450 may be at least one of a cellulose acetate filter, a paper filter, a Balsa filter, or a metal filter, or a combination thereof.

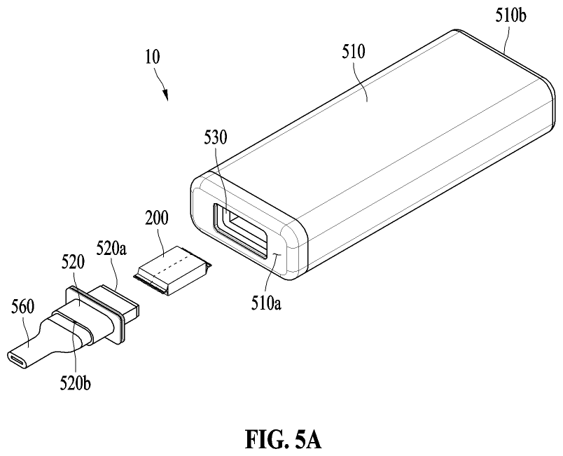

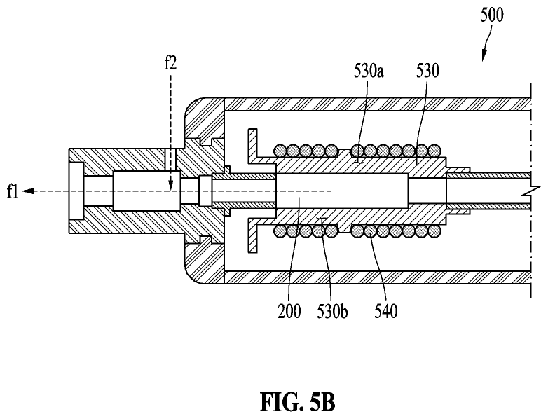

FIG. 5A is a perspective view of an aerosol generating system 10 according to an embodiment. FIG. 5B is a cross-sectional view of the aerosol generating system 10 according to an embodiment.

Referring to FIG. 2A, the aerosol generating system 10 may include an aerosol generating device 500 and the aerosol generating article (200; 300; 400). In an embodiment, the aerosol generating article (200; 300; 400) may be accommodated inside the aerosol generating device 500. In an embodiment, the aerosol generating article (200; 300; 400) may be heated inside the aerosol generating device 500 to form an aerosol. The aerosol generating article (200; 300; 400) has been described in detail with reference to FIGS. 2A to 4B, and therefore, a configuration of the aerosol generating device 500 included in the aerosol generating system 10 will be described in detail below.

Referring to FIGS. 5A and 5B, the aerosol generating device 500 may include a housing 510, an external air inflow unit 520, a medium accommodation portion 530, an induction coil 540, and a mouthpiece unit 560.

The housing 510 according to an embodiment may include a first housing end 510a and a second housing end 510b. The first housing end 510a of the housing 510 may include a surface to be coupled to the external air inflow unit 520. The second housing end 510b of the housing 510 may be formed on a side opposite to the first housing end 510a.

The external air inflow unit 520 according to an embodiment may be coupled to the first housing end 510a of the housing 510. In an embodiment, the external air inflow unit 520 may be detachably coupled to the housing 510. In an embodiment, the external air inflow unit 520 may include a first inflow end 520a that comes into contact with the first housing end 510a of the housing 510, and a second inflow end 520b formed on a side opposite to the first inflow end 520a.

The medium accommodation portion 530 according to an embodiment may have a space in which the aerosol generating article (200; 300; 400) is accommodated. In an embodiment, the medium accommodation portion 530 may be disposed inside the housing 510. In an embodiment, the medium accommodation portion 530 may include a first wall 530a and a second wall 530b facing the first wall 530a. In an embodiment, the medium accommodation portion 530 may accommodate the aerosol generating article (200; 300; 400). In an embodiment, the aerosol generating article (200; 300; 400) accommodated inside the medium accommodation portion 530 may be accommodated to fit tight inside the medium accommodation portion 530. In an embodiment, a width between the first wall 530a and the second wall 530b of the medium accommodation portion 530 may be smaller than or equal to a width of the aerosol generating article (200; 300; 400). For example, the aerosol generating article (200; 300; 400) may be more firmly accommodated inside the medium accommodation portion 530 by a difference between the width of the medium accommodation portion 530 and the width of the aerosol generating article (200; 300; 400).

The induction coil 540 according to an embodiment may heat the aerosol generating article (200; 300; 400) accommodated inside the medium accommodation portion 530. The aerosol generating article (200; 300; 400) heated by the induction coil 540 may form an aerosol. In an embodiment, the induction coil 540 may be disposed in contact with outer surfaces of the first wall 530a and the second wall 530b of the medium accommodation portion 530. In an embodiment, the induction coil 540 may be disposed with a gap to be spaced apart from the outer surfaces of the first wall 530a and the second wall 530b of the medium accommodation portion 530. In an embodiment, the induction coil 540 may be disposed at a position corresponding to a surface including the susceptor (240; 340; 440) of the aerosol generating article (200; 300; 400).

The induction coil 540 may heat the aerosol generating article (200; 300; 400) using an induction heating method. For example, the induction coil 540 may heat the susceptor (240; 340; 440) of the aerosol generating article (200; 300; 400) by applying a variable magnetic field, thereby heating the medium portion (210; 310; 410) in the aerosol generating article (200; 300; 400). In an embodiment, the induction coil 540 may be wound along outer walls of the medium accommodation portion 530, in which the aerosol generating article (200; 300; 400) is accommodated, to induce a variable magnetic field.

The mouthpiece unit 560 according to an embodiment may be disposed in contact with the second end 520b of the external air inflow unit 520. In an embodiment, the mouthpiece unit 560 is a part that the user's mouth directly touches, and the user may inhale an aerosol generated in the aerosol generating system 10 through the mouthpiece unit 560.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents of the claims are within the scope of the following claims.

1. An aerosol generating article comprising:
a medium portion comprising a first medium surface, a second medium surface formed on a side opposite to the first medium surface, and one or more medium side surfaces perpendicular to the first medium surface and the second medium surface;
an outer cover portion comprising a first outer cover surface corresponding to the first medium surface of the medium portion, a second outer cover surface corresponding to the second medium surface, and outer cover side surfaces corresponding to the medium side surfaces, and formed of a porous material; and
a susceptor disposed to correspond to the first outer cover surface and the second outer cover surface,
wherein a medium is transferred by one of a method in which the aerosol generating article is inserted into an aerosol generating device such that the medium is transferred through heating or a method in which the aerosol generating article is inserted into user's mouth such that the medium is directly transferred.

2. The aerosol generating article of claim 1, further comprising:
a wrapper portion configured to wrap at least a portion of the outer cover portion,
wherein the wrapper portion comprises a first wrapper surface corresponding to the first outer cover surface, a second wrapper surface corresponding to the second outer cover surface, and wrapper side surfaces corresponding to the outer cover side surfaces.

3. The aerosol generating article of claim 2, wherein the susceptor surrounds at least a portion of the wrapper portion and a remaining portion of the wrapper portion that is not surrounded by the susceptor has a porous property.

4. The aerosol generating article of claim 3, wherein the susceptor surrounds the first wrapper surface and the second wrapper surface of the wrapper portion.

5. The aerosol generating article of claim 3, wherein
the wrapper side surfaces comprise a third wrapper surface, a fourth wrapper surface formed on a side opposite to the third wrapper surface, a fifth wrapper surface perpendicular to the third wrapper surface and the fourth wrapper surface, and a sixth wrapper surface formed on a side opposite to the fifth wrapper surface, and
the susceptor and the wrapper portion comprise a cutting line drawn from the third wrapper surface to the fourth wrapper surface.

6. The aerosol generating article of claim 1, further comprising:
a wrapper portion,
wherein the susceptor surrounds at least a portion of the outer cover portion and the wrapper portion surrounds the susceptor and the outer cover portion, and
wherein the wrapper portion comprises a first wrapper surface corresponding to the first medium surface, a second wrapper surface corresponding to the second medium surface, and wrapper side surfaces corresponding to the medium side surfaces, and formed of a thermally conductive material.

7. The aerosol generating article of claim 1, further comprising:
a filter portion,
wherein the filter portion contacts with at least one of the outer cover side surfaces.

8. The aerosol generating article of claim 1, wherein the first medium surface and the second medium surface have the same shape and area.

9. An aerosol generating system comprising:
an aerosol generating device; and
an aerosol generating article accommodated inside the aerosol generating device,
wherein the aerosol generating device comprises:
a housing comprising a first housing end and a second housing end on a side opposite to the first housing end;
a mouthpiece unit detachably coupled to the first housing end of the housing;
a medium accommodation portion disposed inside the housing and comprising a first wall and a second wall facing the first wall; and
an induction coil disposed on outside of the first wall and the second wall of the medium accommodation portion to generate an induced magnetic field on the aerosol generating article accommodated in the medium accommodation portion, and
wherein the aerosol generating article comprises:
a medium portion comprising a first medium surface, a second medium surface formed on a side opposite to the first medium surface, and one or more medium side surfaces perpendicular to the first medium surface and the second medium surface;
an outer cover portion surrounding the first medium surface, the second medium surface, and the medium side surfaces of the medium portion, and formed of a porous material; and
a susceptor disposed to correspond to the first medium surface and the second medium surface.

10. The aerosol generating system of claim 9, wherein the susceptor corresponds to at least a portion of the medium side surfaces of the aerosol generating article.

11. The aerosol generating system of claim 9, wherein the induction coil of the aerosol generating device is disposed at a position corresponding to a surface comprising the susceptor of the aerosol generating article.

12. The aerosol generating system of claim 11, wherein
the first medium surface and the second medium surface have the same shape and area, and the shape of the first medium surface and the second medium surface is a rectangle, and
a width between the first medium surface and the second medium surface of the aerosol generating article is larger than or equal to a width between the first wall and the second wall of the medium accommodation portion.
